(19) United States
(12) Patent Application Publication
(10) Pub. No.: US 2014/0059351 A1
(43) Pub. Date: Feb. 27, 2014

(54) METHOD AND DEVICE FOR CONNECTING TO A WIRELESS NETWORK USING A VISUAL CODE

(71) Applicants: Anthony J. Braskich, Palatine, IL (US); Andrew J. Aftelak, Palatine, IL (US); Stephen P. Emeott, Rolling Meadows, IL (US)

(72) Inventors: Anthony J. Braskich, Palatine, IL (US); Andrew J. Aftelak, Palatine, IL (US); Stephen P. Emeott, Rolling Meadows, IL (US)

(73) Assignee: GENERAL INSTRUMENT CORPORATION, Horsham, PA (US)

(21) Appl. No.: 13/590,530

(22) Filed: Aug. 21, 2012

(51) Int. Cl. H04L 9/32

(52) U.S. Cl. 713/171

(57) ABSTRACT

A method for connecting a wireless communication device to a wireless network using a visual code includes reading the visual code that includes an access token that is associated with a wireless access point of the wireless network. The method further includes establishing a secure channel with the wireless access point, and sending the access token to the wireless access point over the secure channel, wherein the access token is used for network access control. Moreover, the method includes receiving security key information from the wireless access point over the secure channel, wherein the security key information is different than the access token. Additionally, the method includes establishing a secure link with the wireless access point using the security key information.

### FIELD OF THE DISCLOSURE

The present disclosure relates generally to wireless network communications and, in particular, to a method and device for connecting a wireless communication device to a wireless network using a visual code.

### BACKGROUND

Wireless local area networks (WLANs) (also referred to herein simply as wireless networks), such as the popular WiFi networks, have become widely accessible in both private and commercial settings. Wireless networks provide access or connection for mobile communication devices (also referred to herein as wireless communication devices) through wireless access points, base stations, and/or other networking devices. Mobile communication devices, such as laptop computers (or laptop for short), smartphones, and tablet computers (or tablet for short), are generally equipped with wireless network interfaces to connect to wireless access points (or other networking devices) for accessing wireless networks.

Wireless networks oftentimes require permission or other credentials such as encryption keys, passwords, etc., for access to, thereby, provide for secure wireless networks. For example, home and small office WiFi networks are usually secured with a symmetric key such as a pre-shared key (PSK), password, or passphrase. A password is a secret word or string of characters that is used for authentication, while a passphrase is generally a sequence of words or other text to provide added security. Symmetric keys, passwords, passphrases, and all other codes used for general, long term, secure communications between devices, are collectively referred to herein as security codes. Security codes can include other types of codes, such as asymmetric keys, that are used to secure network access and/or traffic. Security codes and the information used to derive security codes are referred to collectively herein as security key information.

To access a secure WiFi network using a mobile communication device, a user needs to acquire a security code (e.g., a PSK, password, or passphrase) of the WiFi network before entering the acquired security code on the mobile communication device. This process of accessing or joining a WiFi network is cumbersome, particularly for mobile communication devices without a keyboard or keypad. Additionally, PSKs, passwords, and passphrases present network security risks because they are vulnerable to, for example, offline dictionary attacks. Such network security risks are exacerbated when the PSKs, passwords, and passphrases are simple and/or suggestive. Furthermore, the PSK, password, or passphrase of a WiFi network is generally not changed for some amount of time (e.g., weeks or months). As a result, the security of the WiFi network is weakened or compromised.

Accordingly, there is a need for a method and device for connecting a wireless communication device to a wireless network overcoming at least some of these issues.

### BRIEF DESCRIPTION OF THE DRAWINGS

The accompanying figures, where like reference numerals refer to identical or functionally similar elements throughout the separate views, together with the detailed description below, are incorporated and form part of the specification and serve to further illustrate various embodiments of concepts that include the claimed invention, and to explain various principles and advantages of those embodiments.

FIG. 1 illustrates a block diagram of a wireless communication system implementing some embodiments of the present teachings.

FIG. 2 is a logical flowchart illustrating a method for connecting a wireless communication device to a wireless network using a visual code in accordance with some embodiments.

FIG. 3 is a logical flowchart illustrating a method for providing a visual code to facilitate connecting a wireless communication device to a wireless network using the visual code in accordance with some embodiments.

FIG. 4 is a logical flowchart illustrating a method for facilitating connecting a wireless communication device to a wireless network using a visual code in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments. In addition, the description and drawings do not necessarily require the order illustrated. It will be further appreciated that certain actions and/or steps may be described or depicted in a particular order of occurrence while those skilled in the art will understand that such specificity with respect to sequence is not actually required. Moreover, the content of certain messages (e.g., text messages, e-mails, telephone calls, etc.) may be expressed in particular words and/or phrases while those skilled in the art will understand that such specificity with respect to expression is not actually required.

Apparatus and method components have been represented where appropriate by conventional symbols in the drawings, showing only those specific details that are pertinent to understanding the various embodiments so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

### DETAILED DESCRIPTION

Generally speaking, pursuant to the various embodiments, the present disclosure provides a method for connecting a wireless communication device to a wireless network using a visual code, as defined in more detail below. In accordance with the present teachings, the method includes reading a visual code that includes an access token that is associated with a wireless access point of the wireless network, establishing a secure channel with the wireless access point, and sending the access token to the wireless access point over the secure channel, wherein the access token is used for network access control. The method further includes receiving security key information from the wireless access point over the secure channel, wherein the security key information is different than the access token. Additionally, the method includes establishing a secure link with the wireless access point using the security key information.

Further in accordance with the present teachings is a method and device for facilitating connecting a wireless communication device to a wireless network using a visual code. The device includes at least one network interface, memory device, and processing device operatively coupled to perform the method. The method includes generating a first access token, and encoding the first access token in a visual code. The method further includes providing the visual code for scanning by at least one wireless communication device, and establishing a secure channel with a first wireless communication device. Additionally, the method includes receiving a second access token from the first wireless communication device over the secure channel, and verifying the second access token against the first access token. Moreover, the method includes generating and sending over the secure channel to the first wireless communication device security key information for use in securely accessing the wireless network.

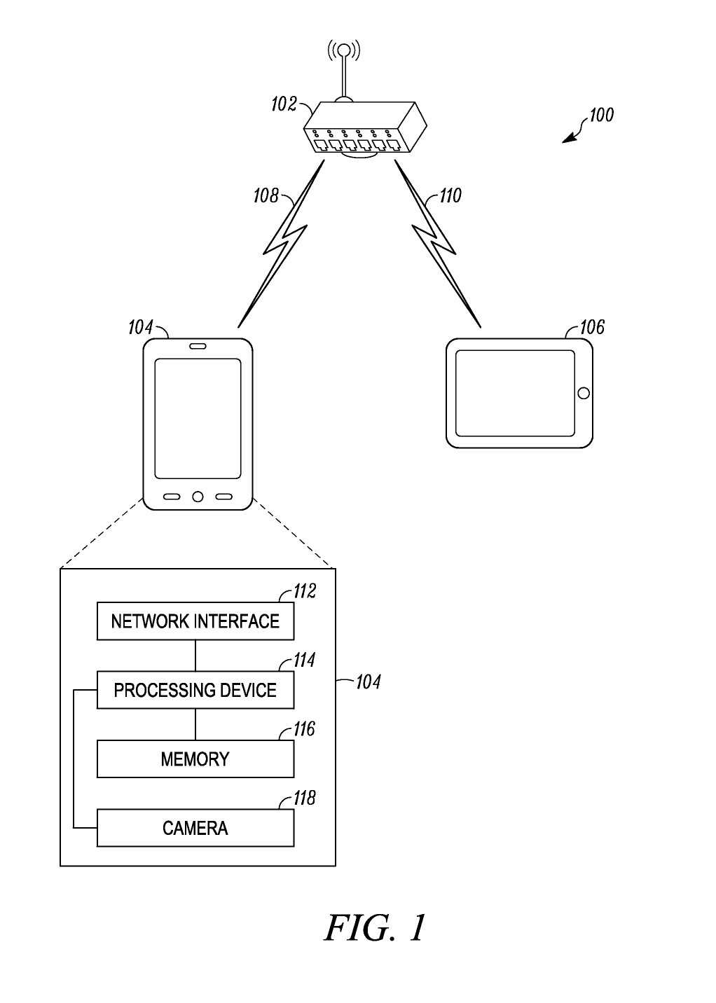

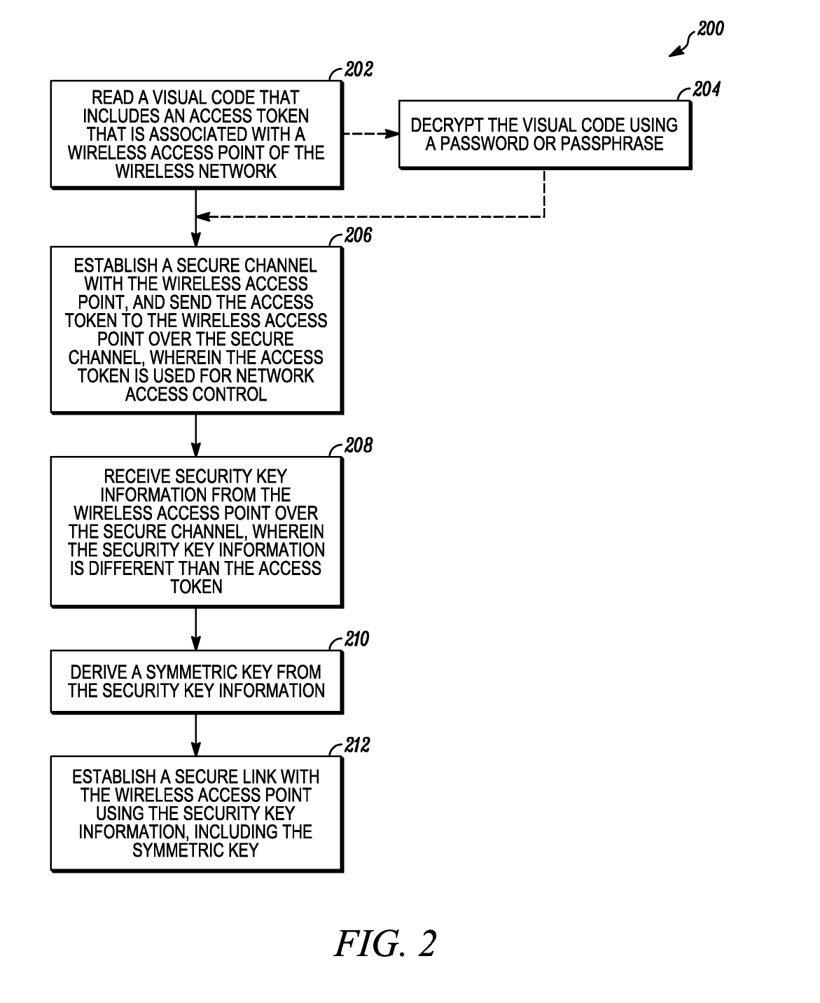

Referring now to the drawings, and in particular FIG. 1, an illustrative wireless communication system implementing embodiments in accordance with the present teachings is shown and indicated generally at 100. As shown, communication system 100 comprises three system elements: a wireless access point 102 and two wireless communication devices that communicate with the wireless access point 102, e.g., a smartphone 104 and a tablet 106. At least some of the system elements 102-106 are configured or adapted to perform methods in accordance with the present teachings. Such methods include, for instance, methods 200, 300, and 400 described by reference to FIGS. 2-4, respectively.

Only a limited number of system elements 102 to 106 are shown for ease of illustration; but additional or fewer such networks and/or elements may be included in the system 100. For example, in an alternative arrangement, system 100 includes one or more other communication devices such as a laptop or a Personal Digital Assistant (PDA), by way of example, in addition to or alternatively to the smartphone 104 and the tablet 106. Moreover, other components needed for a commercial embodiment of the system 100 are omitted from the drawing for clarity in describing the enclosed embodiments. For example, a printer (not shown) may be included within the system 100 to facilitate connecting the smartphone 104 to the wireless network of the wireless access point 102.

The wireless access point 102 allows wireless communication devices (e.g., the smartphone 104 and tablet 106) and/or wired communication devices (such as a desktop computer (not shown)) to connect to a wired network using WiFi, Bluetooth, or other wireless technologies. As used herein, WiFi refers to a wireless technology based on Institute of Electrical and Electronics Engineers' (IEEE) 802.11 standards. The IEEE 802.11 technology allows an electronic device, such as the smartphone 104 or the tablet 106, to connect to a network resource (such as the Internet) and exchange information wirelessly (using radio waves) via a wireless access point such as the wireless access point 102. Such information includes, but is not limited to, media, visual codes, security key information, security certificate information, access tokens, connection parameters (i.e., network connection parameters), etc., which can be used to implement one or more methods in accordance with the present teachings. Accordingly, a wireless access point that is configured to operate in accordance or in compliance with the 802.11 standards is termed herein as a WiFi access point; and a wireless network comprising one or more WiFi access points is a WiFi network.

A wireless access point usually connects to a router (not shown) via a wired network, and relays data between wireless communication devices connected to the wireless access point and network devices (not shown) connected to the wired network. Additionally, the wireless access point bridges communications between the wireless communication devices that are connected to the wireless access point. Since the wireless access point communicates with wireless communication devices using wireless connections, it can be said that the wireless access point is associated with and a part of a wireless network. Only one wireless access point 102 is shown in system 100; however, the wireless network could comprise additional wireless access points in different locations to extend the wireless coverage for the wireless network.

As shown, the smartphone 104 communicates with the wireless access point 102 over a wireless connection 108 (such as a WiFi link). Through the wireless connection 108, the smartphone 104 accesses the wireless network associated with and facilitated by the wireless access point 102. The wireless access point 102 further connects and communicates with the tablet 106 over a connection 110 (wired or wireless) to exchange at least some of the above-mentioned information. In one implementation, the connection 110 is a WiFi or Bluetooth link. In an alternate implementation, the connection 110 is a wired link, such as a Universal Serial Bus (USB) link or an Ethernet link.

As used herein, a “connection” enables two devices to communicate and includes the resources, wired or wireless, and network infrastructure (if any) used to facilitate the communications. A link is a point-to-point connection established between two devices without the need for any intervening device. Whereas a channel between two devices may include other intervening devices such as routers and servers to facilitate the connection. A connection is “secure” (e.g., a secure channel or a secure link) when access to a wireless access point at the other end of the connection or to traffic sent over the connection is controlled and accessible to a limited number of communication devices by the use of one or more of: security codes, security or encryption protocols, or authentication protocols. When a wireless communication device establishes a secure link with a wireless access point, the wireless communication device is said to be securely accessing the wireless network associated with the wireless access point.

Where a wireless communication device, in this illustrative embodiment the smartphone 104, of system 100 securely accesses the wireless network via the wireless access point 102, a WLAN security association (WLAN SA) is established. An SA is a relationship between two communication devices for secure communication. In accordance with the present teachings, there are two types of WLAN SAs: general-purpose WLAN SA (General SA) and Bootstrap SA. A General SA is used to secure general-purpose communications (such as exchange of voice, text, and video data) between a wireless communication device and the wireless access point 102.

However, in accordance with the present teachings, a Bootstrap SA is used to establish the General SA, but is not itself used for securing general-purpose communications between the smartphone 104 and the wireless access point 102. In one embodiment, the Bootstrap SA is established over an unsecured wireless link that is established, between the smartphone 104 and the wireless access point 102, using an unsecured portion of the wireless network. Furthermore, the Bootstrap SA is used to securely send security key information from the wireless access point 102 to the smartphone 104. The security key information is subsequently used to establish the General SA between the smartphone 104 and the wireless access point 102. One direct benefit of the two layers of WLAN SA is that the wireless access point 102 and the smartphone 104 do not have to have pre-existing shared security key information for establishing a secure link between them.

In general, as used herein, the system elements 102-106 or their hardware being “configured” or “adapted” means that such elements are implemented using one or more memory devices (e.g., 116), network interfaces (e.g., 112), and/or processing devices (e.g., 114) that are operatively coupled, and which, when programmed, form the means for these system elements to implement their desired functionality, for example, as illustrated by reference to the methods shown in FIGS. 2-4. FIG. 1 only shows the network interface 112, processing device 114, and memory 116 for smartphone 104 for the purpose of clarity. However, access point 102 and tablet 106 each have similar network interfaces, processing devices and memory devices operatively coupled to perform their respective functionality. Moreover, smartphone 104 further includes a scanning device 118, such as a camera, for implementing scanning functionality, as described in detail below. In an embodiment, tablet 104 also contains a camera.

The network interfaces are used for passing signaling also referred to herein as messaging (e.g., messages, packets, datagrams, frames, superframes, and the like) containing control information, voice or non-voice media (e.g., text), or other information as mentioned above between the elements of the system 100. The implementation of the network interface in any particular element depends on the particular type of network, i.e., wired and/or wireless, to which the element is connected. Where the network supports wireless communications, the network interfaces comprise elements including an antenna and processing, modulating, and transceiver elements that are operable in accordance with any one or more standard or proprietary wireless interfaces, wherein some of the functionality of the processing, modulating, and transceiver elements may be performed by means of the processing device through programmed logic such as software applications or firmware stored on the memory device of the system element or through hardware.

The processing devices utilized by the elements of system 100 may be partially implemented in hardware and, thereby, programmed with software or firmware logic or code for performing functionality described by reference to FIGS. 2-4; and/or the processing devices may be completely implemented in hardware, for example, as a state machine or ASIC (application specific integrated circuit). The memory implemented by these system elements can include short-term and/or long-term storage of various information needed for the functioning of the respective elements. The memory may further store software or firmware for programming the processing device with the logic or code needed to perform its functionality.

We now turn to a detailed description of the functionality of the system 100 elements in accordance with the teachings herein and by reference to the remaining figures. FIG. 2 illustrates a logical flow diagram showing a general method 200 performed by a wireless communication device, in this example embodiment the smartphone 104. Method 200 begins at 202 with the wireless communication device 104 reading a visual code that includes an access token that is associated with a wireless access point, in this example embodiment the wireless access point 102, of the wireless network that the smartphone 104 is attempting to access.

A visual code (also interchangeably referred to herein as optical code) is a machine-readable optical representation of information or data. The represented information or data of the visual code is termed herein as content of the visual code. One-dimensional barcodes and multi-dimensional (e.g., two-dimensional) barcodes are example visual codes. The content of the visual code includes an access token, and in at least one embodiment also includes network access information. An access token (also known in the art as a secure or security token or an authentication token) is a randomly or pseudo-randomly generated numeric or alphanumeric sequence used during an authentication procedure, for instance to authenticate a wireless communication device to a wireless access point. An access token is associated with a wireless access point when, for instance, the wireless access point generates or otherwise provides the access token or the access token is used by the wireless access point to authenticate one or more wireless communication devices.

Network access information, in one example embodiment, includes, but is not limited to, a Service Set Identifier (SSID), a web services address, and security certificate information of a WiFi access point. The SSID and web services address are used to access an unsecured portion of the wireless network. The unsecured portion of a wireless network allows a wireless communication device to form a connection with the wireless access point without having a WLAN SA. The security certificate information comprises, for example, a security certificate (such as an X.509 certificate) that identifies the wireless access point 102. Alternatively, a security certificate is derived from data or information contained in the security certificate information. Accordingly, it can be said that reading the visual code comprises reading security certificate information and a web services address of the wireless access point.

Turning again to 202, reading a visual code includes scanning the visual code, as displayed on a screen of a communication device (in this case the screen of the tablet 106) or printed on paper or other medium, and decoding the scanned image of the visual code to retrieve or obtain the contents of the visual code. Visual codes are scanned by optical scanners, such as barcode readers. Barcode scanners and interpretive software are often available on devices including desktop printers and smartphones. For example, using an imaging device such as a camera, the smartphone 104 scans a two-dimensional barcode displayed on the tablet 106 and uses interpretive software to understand and interpret (i.e., decode) the content of the scanned two-dimensional barcode. Accordingly, in this example, the visual code is a two-dimensional barcode, and reading the visual code comprises scanning the visual code using an imaging device of the wireless communication device. In a different implementation, the visual code is printed on paper or stored on an electronic medium, such as a computer disk, to be displayed for scanning at a later time by the wireless communication device 104.

In some scenarios, such as someone entering a home or small business with a wireless communication device, a person may desire access to a WLAN within the home or business but not have any information needed to access the WLAN, e.g., a security code, security parameters, and network connection parameters. In such a case, an authorized person (referred to herein as an administrator or a member) for a wireless access point of the WLAN uses a communication device, in this case the tablet 106, with a secure connection to the wireless access point to facilitate providing the wireless communication device with the information needed to access the WLAN. As used herein, an authorized person for the wireless access point has permissions to join a user (or the user's wireless communication device), referred to herein as a “joiner,” to the wireless access point and, thereby to the wireless network.

An administrator has greater permissions than a member, meaning that an administrator can control access to a private portion of the wireless network that is not accessible by members or guest users. Additionally, an administrator can access the wireless network through an SSID reserved by the wireless access point for privileged operation. Moreover, in an embodiment the member needs authorization from the administrator to join a user to the wireless network, or the member has limited privileges for setting connection parameters to control access to the wireless network.

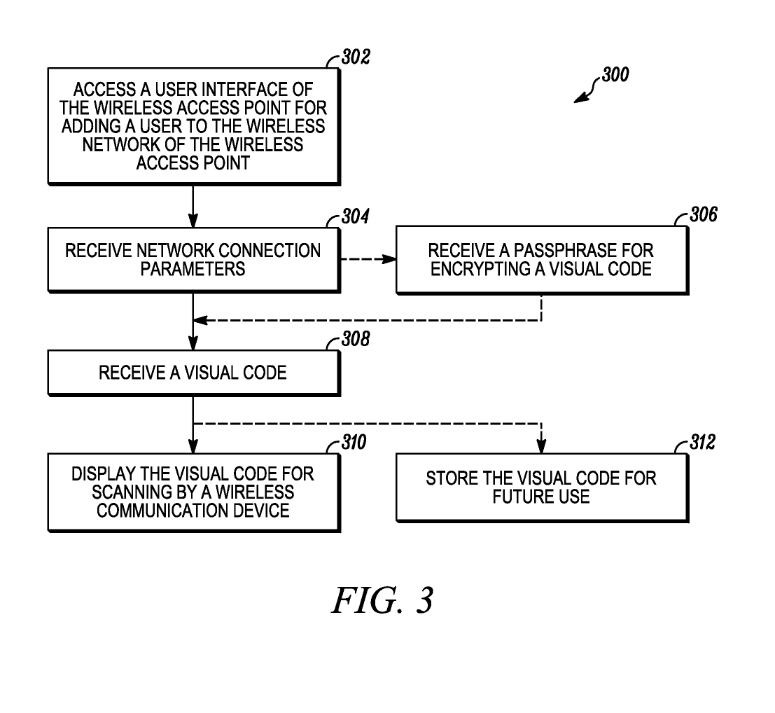

As stated earlier, in an embodiment (at 202), the smartphone 104 reads a visual code displayed on the screen of the tablet 106 to begin the process of adding a user to a wireless network, wherein an authorized person operates the tablet 106 to provide this visual code. FIG. 3 illustrates a general method 300 implemented in a device used by an authorized person (e.g., the member or the administrator). The method 300 is implemented to facilitate providing information to a wireless communication device (such as the visual code) for connecting to a wireless network that is associated with and facilitated by the wireless access point. Based on the example system embodiment, the device used by the authorized person for the wireless access point is the tablet 106, the wireless access point is the wireless access point 102, and the wireless communication device is the smartphone 104.

At 302, the tablet 106 provides a user interface for receiving input from an authorized person for the wireless access point 102 to add a joiner to the wireless network. In an embodiment, the user interface is a web interface that allows the authorized person to access and configure the wireless access point 102 and to submit a request for adding a joiner or new user to the wireless network. To access the web interface, the authorized person of the wireless access point 102 simply launches a mobile device application or a web browser on the tablet 106 and accesses the web interface using a username and password combination or other authentication technique. Responsive to the request to add a joiner, the wireless access point 102 (among other functions) generates an access token that is associated with the wireless access point 102, as it is used to communicate with the wireless access point 102. For example, in one implementation, the wireless access point 102 authenticates only wireless communication devices presenting access tokens that are generated by the wireless access point 102. In such a case, the access token associated with the wireless access point 102 is generated by the wireless access point 102.

The tablet 106, at 304, receives network connection parameters from the authorized person to provide to the wireless access point 102. Alternatively, one or more default network connection parameters are provided to the wireless access point 102. The authorized person sets a network connection parameter by selecting the network connection parameter and configuring a setting or value for the network connection parameter. Network connection parameters can include, but are not limited to, expiration time, type of network access, and number of times of uses of an access token. The expiration time is applicable to the access token and/or a network connection that is established using the access token. The type of network access specifies the nature of network connections for the wireless communication device, such as access to only the Internet or access to a private network. Where a number of uses for an access token is set or configured, the access token, or the visual code that includes the access token, can no longer be used to gain access to the wireless network once the access token has been used for that number of times.

In an example implementation, an administrator revises or upgrades a set (meaning one or more) of network connection parameters. For example, where a member uses his communication device to add a joiner at 302, default network connection parameters are used and associated with the joiner. In such a case, the wireless access point 102 or the member's communication device notifies the administrator of the joiner, for instance using an email notification. Responsive to the notification, the administrator accesses the wireless access point 102 and configures and sets network connection parameters for the joiner.

In some situations, it is desirable to secure visual codes using passwords or passphrases. For instance, a two-dimensional barcode is generated and stored for future use but may not be kept physically secure. Accordingly, at 306, the tablet 106 receives a passphrase or password for encrypting the visual code from an authorized person of the wireless access point 102. In addition, at 306, the tablet 106 sends the received passphrase or password to the wireless access point 102 to perform such encryption. As used herein, encrypting a visual code means encrypting content of the visual code. Similarly, decrypting an encrypted visual code means decrypting content of the encrypted visual code.

At 308, the communication device receives the visual code, containing an access token and network access information, from the wireless access point 102. Where a passphrase is set at 306, the content of the received visual code is encrypted by the wireless access point 102 using the passphrase. At 310, the tablet 106 displays the received visual code for scanning by the smartphone 104. Alternatively, at 312, the tablet 106 stores the visual code on an electronic medium, such as a computer disk, to be displayed for scanning at a later time by the smartphone 104 or other wireless communication devices.

In another alternate embodiment, the received the visual code is printed on paper or other medium that is placed in a physically secure location for future use. In one implementation, the visual code is posted or displayed in a physically secure location close to the wireless access point. Accordingly, any device in close physical proximity to the wireless access point can read the visual code for accessing the wireless network. Limiting access to visual codes within secure locations helps minimize or prevent unauthorized devices from receiving an access token. Alternatively, an administrator sets connection parameters for each connection, such as by establishing policies that the wireless access point follows when generating visual codes. Additionally, an administrator sets parameters indicating when the visual code expires or a fixed number of uses.

Changing the visual code, either periodically or after use by one or more devices, helps minimize or prevent network access using visual codes that are leaked outside the secure environment. In a further implementation, an administrator creates a visual code for long term use, and displays the visual code in a physically secure location. Two devices reading the same long term use visual code still establish independent secure connections with the wireless access point and receive unique security key information for establishing a secure link.

Turning back to FIG. 2, where the scanned (at 202) visual code is encrypted using a password or passphrase, the smartphone 104 (at 204) decrypts the visual code or contents of the visual code using the same password or passphrase. For example, when the smartphone 104 scans an encrypted two-dimensional barcode, it prompts the user of smartphone 104 to enter a password or passphrase for decrypting the two-dimensional barcode. In one illustrative implementation, the administrator or member (or another authorized person for the wireless network) verbally supplies the password or passphrase to the user of the smartphone 104. Such verbal communication of the password or passphrase prevents electronic eavesdropping of this information by other devices in the area.

At 206, the smartphone 104 establishes a secure channel with the wireless access point 102, and sends the access token to the wireless access point 102 over the secure channel, wherein the access token is used for network access control. In one embodiment, the smartphone 104 creates the secure channel with the wireless access point 102, identified by the SSID that is included in the visual code scanned and read at 202, by establishing a Hypertext Transfer Protocol Secure (HTTPS) connection (as defined in Internet Engineering Task Force (IETF) Request for Comments (RFC) 2818 dated May 2002 (including previous or subsequent revisions)) to the web services address included in the same visual code. The secure channel using the HTTPS protocol is a Bootstrap SA since it is created for the purpose of establishing a General SA, as illustrated later.

In establishing the secure channel over the HTTPS protocol, the smartphone 104 and the wireless access point 102 perform a handshake procedure conforming to Transport Layer Security (TLS) or Secure Sockets Layer (SSL) specifications. During the handshake procedure, the wireless access point 102 sends its identification, to the smartphone 104, in the form of a security certificate, such as an X.509 digital certificate. A security certificate usually contains a server name, a trusted certificate authority (CA), a signature created by the trusted CA, and the server's public encryption key.

Responsive to reception of the security certificate from the wireless access point 102, the smartphone 104, at 206, authenticates the wireless access point 102 by validating the received security certificate against the security certificate information contained in the visual code. The security certificate information contained in the visual code comprises a security certificate or information for deriving the security certificate of the wireless access point 102. Additionally or alternatively, the security certificate information includes a security certificate of a trusted CA or a public encryption key of the trusted CA. Where the security certificate information comprises information for deriving a security certificate, the smartphone 104, at 206, further derives the security certificate from the security key information. In one implementation, two security certificates (such as X.509 certificates) are successfully validated where they are identical. In a further implementation, a security certificate (such as an X.509 certificate) is successfully validated when the signature contained within the security certificate is validated using the public encryption key of a trusted CA contained in the visual code.

As discussed above, the SSID and web services address are associated with an unsecured portion of the wireless network. Accordingly, it can be said that establishing the secure channel with the wireless access point comprises establishing a secure connection over an unsecured portion of the wireless network using at least the web services address of the wireless access point and the Hypertext Transfer Protocol Secure protocol. Moreover, in the above embodiment, establishing the secure channel with the wireless access point further comprises establishing the secure connection over the unsecured portion of the wireless network using the security certificate information.

Furthermore, upon successful authentication of the wireless access point 102, at 206, the smartphone 104 sends, to the wireless access point 102, over the secure HTTPS channel, the access token contained in the visual code that is read at 202. Responsively, the wireless access point 102 verifies that the access token it receives from the smartphone 104 is the same as the access token that it generated and encoded in the visual code. Accordingly, the network security of the wireless network is enhanced by the authentication and group membership authentication between the smartphone 104 and the wireless access point 102. More particularly, the smartphone 104 authenticates the wireless access point 102 by validating the security certificate information received from the wireless access point 102. Moreover, the wireless access point 102 performs group membership authentication to validate that the smartphone 104 belongs to the group of wireless communications devices authorized to join the wireless network. Such validation is performed by verifying that the access token received from the smartphone 104 is identical to the access token contained in the visual code.

Upon successful verification of the access token, the wireless access point 102 generates security key information for establishing the WLAN SA and secure communications between the smartphone 104 and the wireless access point 102. In one embodiment, the security key information includes a symmetric key or is used to derive a symmetric key for securing traffic sent over the wireless network. A symmetric key is a security key, such as a PSK, that is known to two communication devices that are communicating with each other. In addition to the security key information, the wireless access point 102 also sends in any suitable data structure, to the smartphone 104, over the secure HTTPS connection, other network access information concerning the wireless network.

For instance, the wireless access point 102 sends a SSID of a secured portion of the wireless network, authentication and key management suite identifiers, cipher suite identifiers, and other security parameters to the smartphone 104, wherein the secured portion is only accessible using a General SA. The security parameters may further comprise one or more of the following: a Basic Service Set Identifier (BSSID) that identifies a wireless access point; a description of the authentication type; a description of allowed group ciphers (such as Counter Cipher Mode with Block Chaining Message Authentication Code Protocol (CCMP), Temporal Key Integrity Protocol (TKIP), 40 Bit Wired Equivalent Privacy (WEP-40), or 104 Bit Wired Equivalent Privacy (WEP-104)); a description of supported key management protocols (such as Wi-Fi Protected Access PSK (WPA-PSK)); a description of supported pair wise ciphers for WPA (e.g., CCMP or TKIP); or a description of permitted security protocols (such as, WPA or WPA2).

In this case, the security key information is included in a data structure that also comprises an identifier for the wireless network and security parameters for the wireless network. In a further embodiment, the security key information is unique to the smartphone 104 or a user of the smartphone 104. For instance, a new and unique symmetric key (e.g., a PSK) is generated, by the wireless access point 102, for each wireless communication device or a user of the wireless communication device. Additionally, the security key contained in or derived from the security key information is different from the access token.

At 208, the wireless communication device receives the security key information from the wireless access point over the secure channel established using the HTTPS protocol, wherein the security key information is different than the access token. At 210, the wireless communication device derives a symmetric key (e.g., a PSK for a WiFi network) or another type of security key from the security key information that is received at 208. Where the security key information includes a security key, the smartphone 104, at 208, obtains the security key from the security key information.

When the security key information is contained in a data structure that also includes other network access information and security parameters, at 210, the smartphone 104 unpacks the data structure to extract from the data structure the contained network access information and security parameters, such as the SSID and web services address of a secured portion of a WiFi network. At 212, the smartphone 104 establishes a secure link with the wireless access point 102 using the security key information, for instance the symmetric key for a WiFi network. In other words, wireless network traffic over the secure link between the wireless access point 102 and the smartphone 104 is secured using the symmetric key. Accordingly, the security key information is associated with and facilitates a General SA between the smartphone 104 and the wireless access point 102 over the secure link.

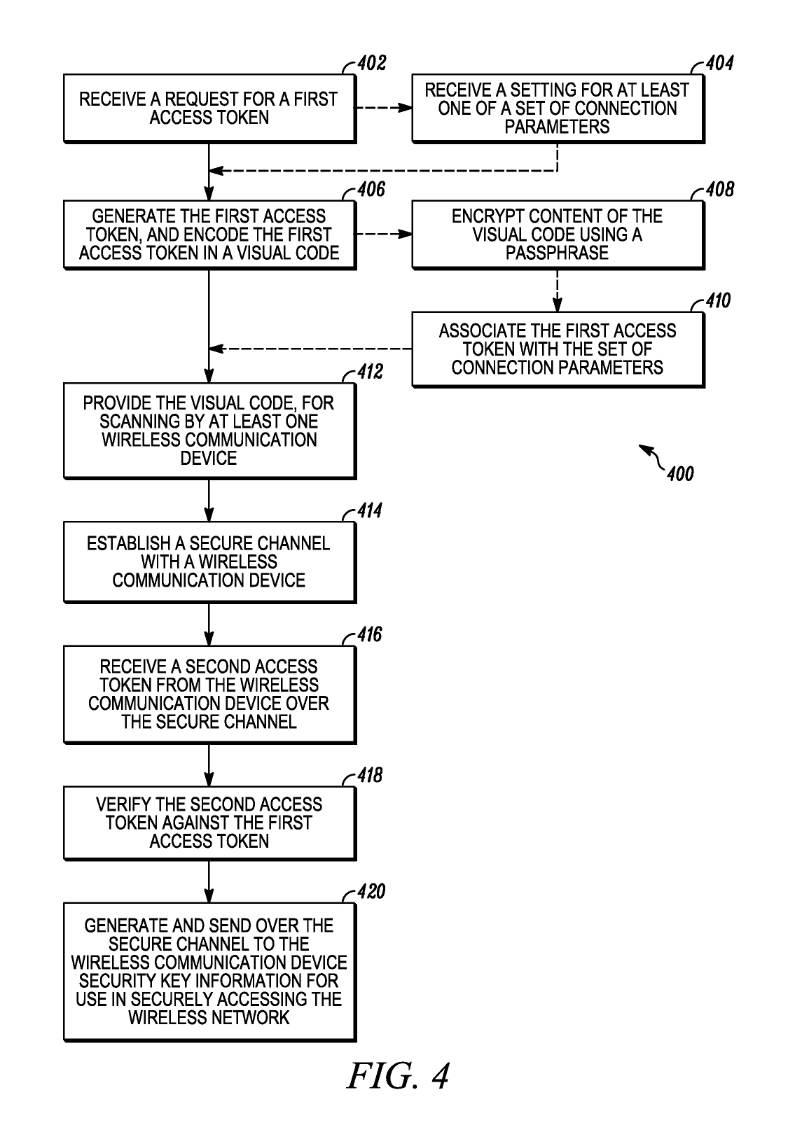

Referring now to FIG. 4, a general method 400 performed by device, such as a wireless access point, for facilitating connecting a wireless communication device to a wireless network is shown. In the example embodiment, the wireless access point is the wireless access point 102, and the wireless communication device is the smartphone 104. In accordance with the present teachings, the smartphone 104 reads a visual code that is displayed on the screen of the tablet 106 and provided by the wireless access point 102 using method 400, for example. In one example implementation, method 400 starts at 402, where the wireless access point 102 receives a request for a first access token. For example, the wireless access point 102 receives such a request when the tablet 106 performs 302 of FIG. 3 to add a joiner to the wireless network.

In a further implementation, the authorized person of the wireless access point 102 specifies a setting for one or more connection parameters when a joiner is added to the wireless network at 302. Accordingly, at 404, the wireless access point 102 receives, from the tablet 106, a setting for at least one connection parameter. The received setting is used for new network connections between the smartphone 104 and the wireless access point 102. Connection parameters, such as expiration time and access type, are used to control access to the wireless network. The wireless access point 102 further associates (410) the generated access token with the network connection parameters that are set at 304. For example, the wireless access point 102 stores the access token and the set of connection parameters as a pair in memory, a disk, or a database. Where the authorized person does not set network connection parameters or the authorized person does not have an administrator's privileges to set network connection parameters, default network connection parameters and default settings for the default network connection parameters are applied and associated with the access token, at 410.

To return or provide the first access token to the tablet 106, at 406, the wireless access point 102 generates the first access token, and encodes the first access token in a visual code. In the above-described embodiment, the access token is generated and encoded into the visual code in response to a request, such as from an authorized person (e.g., an administrator or member) using the tablet 106. In an alternate embodiment, the wireless access point generates the visual code, which is displayed to one or more wireless communication devices, without direct intervention from an administrator or member. Accordingly, instead of starting method 400 at 402, method 400 starts at 406, with the wireless access point automatically generating the access token.

In one embodiment, the visual code is a two-dimensional barcode. Thus, in this case, the visual code is a multi-dimensional barcode. In a further embodiment, in addition to the first access token, at 406, the wireless access point encodes an SSID and web services address of an unsecured portion of the wireless network in the two-dimensional barcode. Moreover, at 406, the wireless access point 102 encodes security certificate information (such as an X.509 certificate) of the wireless access point 102 into the two-dimensional barcode.

Where it is desirable or necessary to further secure the visual code, at 408, the wireless access point encrypts the content of the visual code using a passphrase or password, before associating the set of connection parameters with the first access token, at 410. In this case, it can be said that the visual code is encrypted using a passphrase or password.

At 412, the wireless access point 102 provides the visual code for scanning by at least one wireless communication device, which in this example embodiment is the smartphone 104. More particularly, responsive to the request of 402, the wireless access point 102 returns and provides the visual code to the tablet 106, which subsequently displays the visual code for scanning by the smartphone 104. In a further embodiment, the connection between the wireless access point 102 and the tablet 106 is a secure connection, such as a direct Ethernet link, a direct USB link, or a HTTPS connection over a wireless link. In such a case, the visual code is provided by a wireless access point of the wireless network for visual display on a device having a secure connection with the wireless access point.

The smartphone 104 scans the visual code displayed on the screen of the tablet 106. Alternatively, the smartphone 104 scans a visual code printed on paper. Upon successful scanning of the visual code, the smartphone 104 decodes the scanned image of the visual code, and obtains the first access token and the SSID and web services address of the wireless access point from the visual code. Using the SSID and the web services address, the smartphone 104 initiates creation of a secure channel, such as a HTTPS connection, with the wireless access point 102. Responsively, at 414, the wireless access point 102 establishes the secure channel using the HTTPS protocol with the smartphone 104.

In establishing the HTTPS secure channel, the wireless access point 102 and the smartphone 104 jointly perform a handshake procedure. During the handshake procedure, the wireless access point 102 sends its security certificate information, such as an X.509 certificate, to the smartphone 104. In response to reception of the security certificate information, the smartphone 104 authenticates the wireless access point 102 by validating the received security certificate information against the security certificate information encoded in the visual code at 406.

Upon successful establishment of the secure channel, the wireless access point 102 receives, at 416, an access token from the smartphone 104, which is termed herein as a “second access token.” At 418, the wireless access point 102 verifies the second access token against the first access token by checking whether they match. Where the second access token matches (i.e., is the same as or identical to) the first access token, the wireless access point 102 regards the smartphone 104 as successfully authenticated. Accordingly, in one embodiment, verifying the second access token against the first access token comprises confirming that the first access token and the second access token are identical.

In a further embodiment, where the second access token is successfully verified, the wireless access point 102 generates a new access token when it receives a new request for an access token, at 402, wherein method 400 is repeated. In this case, generating the first access token comprises generating a new first access token when the second access token is successfully verified. Where the second access token matches the first access token, at 420, the wireless access point 102 generates security key information for the smartphone 104 to use to securely access the wireless network. In one embodiment, the wireless access point 102 is a WiFi access point, and the security key information is a data structure that includes a symmetric key or information to derive a symmetric key for securing traffic of the WiFi network. Accordingly, in this example embodiment, it can be said that the security key information is used to derive a symmetric key for use in WiFi network encryption. In one embodiment, the symmetric key, e.g., a PSK, is known only to the smartphone 104 and the wireless access point 102 to strengthen security of the wireless network.

In an implementation where the first access token is used to grant network access to multiple wireless communication devices, the wireless access point 102, at 420, generates different security key information for each of the multiple wireless communication devices. Thus, in this case, the multiple wireless communication devices are each provided different security key information. Moreover, at 420, the wireless access point 102 sends the security key information to the smartphone 104, over the secure channel established at 414, to use in securely accessing the wireless network. The HTTPS secure channel is, thereby, a Bootstrap SA for establishing a General SA.

In a further implementation, at 420, the wireless access point 102 couples or associates the security key information with the connection parameters that are associated with the first access token. Furthermore, where the smartphone 104 establishes a secure link (such as the secure link established at 212) using the security key information, the wireless access point 102 applies the connection parameters to the secure link. One direct benefit of this embodiment is that different classes of users of the wireless access point 102 can be created. For example, one user is allowed to access only the Internet while another user is allowed to access both the Internet and other wireless devices connected to the wireless network. In another example, one user is given a onetime access for four hours, and another user is given unlimited access to the wireless network.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method for connecting to a wireless network using a visual code as described herein. The non-processor circuits may include, but are not limited to, a radio receiver, a radio transmitter, signal drivers, clock circuits, power source circuits, and user input devices. As such, these functions may be interpreted as steps of a method to perform the connecting to a wireless network using a visual code described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Both the state machine and ASIC are considered herein as a “processing device” for purposes of the foregoing discussion and claim language.

Moreover, an embodiment can be implemented as a non-transient computer-readable storage element or medium having computer readable code stored thereon for programming a computer (e.g., comprising a processing device) to perform a method as described and claimed herein. Examples of such computer-readable storage elements include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method, performed by a wireless communication device, for connecting to a wireless network using a visual code, the method comprising:
reading a visual code that includes an access token that is associated with a wireless access point of the wireless network;
establishing a secure channel with the wireless access point, and sending the access token to the wireless access point over the secure channel, wherein the access token is used for network access control;
receiving security key information from the wireless access point over the secure channel, wherein the security key information is different than the access token; and
establishing a secure link with the wireless access point using the security key information.

2. The method of claim 1, wherein reading the visual code comprises reading security certificate information and a web services address of the wireless access point.

3. The method of claim 2, wherein establishing the secure channel with the wireless access point comprises establishing a secure connection over an unsecured portion of the wireless network using at least the web services address of the wireless access point and Hypertext Transfer Protocol Secure protocol.

4. The method of claim 1, wherein the security key information is included in a data structure that also comprises an identifier for the wireless network and security parameters for the wireless network.

5. The method of claim 1, wherein the security key information is used to derive a symmetric key for securing traffic sent over a WiFi network.

6. The method of claim 1, wherein the security key information is unique to the wireless communication device or a user of the wireless communication device.

7. The method of claim 1, wherein the visual code is a two-dimensional barcode, and reading the visual code comprises scanning the visual code using an imaging device of the wireless communication device.

8. A method for facilitating connecting a wireless communication device to a wireless network using a visual code, the method comprising:
generating a first access token, and encoding the first access token in a visual code;
providing the visual code for scanning by at least one wireless communication device;
establishing a secure channel with a first wireless communication device;
receiving a second access token from the first wireless communication device over the secure channel;
verifying the second access token against the first access token; and
generating and sending over the secure channel to the first wireless communication device security key information for use in securely accessing the wireless network.

9. The method of claim 8, wherein verifying the second access token against the first access token comprises confirming that the first access token and the second access token are identical.

10. The method of claim 9, wherein generating the first access token comprises generating a new first access token when the second access token is successfully verified.

11. The method of claim 8, wherein the first access token is used to grant network access to multiple wireless communication devices, which are each provided different security key information.

12. The method of claim 8, wherein the visual code is encrypted using a passphrase or password.

13. The method of claim 8, wherein establishing the secure channel comprises establishing a Hypertext Transfer Protocol Secure connection, and authenticating a wireless access point of the wireless network using security certificate information provided in the visual code.

14. The method of claim 8, wherein the security key information is used to derive a symmetric key for use in WiFi encryption, and wherein the symmetric key is known only to the first wireless communication device and the wireless access point.

15. The method of claim 8 further comprising associating a set of network connection parameters with the first access token, wherein the set of network connection parameters is used to control access of the first wireless communication device to the wireless network.

16. The method of claim 15 further comprising receiving, from an administrator, a setting for at least one of the network connection parameters in the set.

17. The method of claim 8, wherein the visual code is provided by a wireless access point of the wireless network for visual display on a device having a secure connection with the wireless access point.

18. The method of claim 8, wherein the first access token is generated and encoded into the visual code in response to input from an authorized person into a user interface.

19. A device for facilitating connecting a wireless communication device to a wireless network using a visual code, the device comprising, at least one network interface, processing device and memory device that are operatively coupled to:
generate a first access token, and encoding the first access token in a visual code;
provide the visual code for scanning by at least one wireless communication device;
establish a secure channel with a first wireless communication device;
receive a second access token from the first wireless communication device over the secure channel;
verify the second access token against the first access token; and
generate and send over the secure channel to the first wireless communication device security key information for use in securely accessing the wireless network.

20. The device of claim 19, wherein the visual code is a multi-dimensional barcode.
